(19) United States
(12) Patent Application Publication
(10) Pub. No.: US 2011/0157242 A1
(43) Pub. Date: Jun. 30, 2011

(54) DISPLAY DEVICE INCORPORATING BACKLIGHT PLATE COMPOSED OF EDGE-LIT LIGHT GUIDES AND METHOD OF UNIFYING LIGHT EMISSION FROM SAME

(75) Inventor: Tsung-I Wang, Kuei-Shan Hsiang (TW)

(73) Assignee: DYNASCAN TECHNOLOGY CORP., Kuei-Shan Hsiang (TW)

(21) Appl. No.: 12/844,824

(22) Filed: Jul. 27, 2010

(30) Foreign Application Priority Data
Dec. 24, 2009 (TW) 98144738

(51) Int. Cl. G09G 5/10

(52) U.S. Cl. 345/690

(57) ABSTRACT

The invention relates to a display device incorporating a backlight plate composed of edge-lit light guides and a method of unifying the light emission from the display device. The display device has a backlight plate composed of light guides adjacent to one another for guiding light from light sources, a liquid crystal panel disposed at a light exit side of the backlight plate and including cells with adjustable transmissivities, a memory device that stores data regarding light emission intensity distributions of the light guides, and a control device for computing compensation data and controlling the transmissivities of the cells. The light emission of the backlight is unified using the local-area dimming control technique by computing the light emission intensity distributions of the light guides and by obtaining the adjusted image signals for adjusting the transmissivities of the cells.

### FIELD OF THE INVENTION

The present invention relates to a method of unifying the light emission from a display device and, more particularly, to a display device incorporating a backlight plate composed of edge-lit light guides and a method of unifying the light emission from the display device.

### DESCRIPTION OF THE RELATED ART

Liquid crystal display (LCD) devices are now widely utilized in a variety of applications. An LCD device is advantageous over a traditional cathode ray tube (CRT) display device in many aspects, such as lightweight, compact, higher image resolution and less power consumption. All of these lead to a trend towards replacement of traditional CRT display devices with LCD devices.

In place of the then-mainstream cold cathode fluorescent lamps, light-emitting diodes (LED) lamps are increasingly adopted as a backlight source for LCD devices. The backlight plates that employ LEDs as a light source are normally of one of the following types:

(1) direct-lit backlight plates, in which a plurality of LEDs are arranged to constitute a surface light source emitting light directly towards an LCD panel; and

(2) edge-lit backlight plates, in which LED lamps are arranged in the form of a light bar capable of launching light into a side face of a light guide set composed of several light guides.

While the edge-lit backlight plates composed of edge-lit light guides have been shown to exhibit many advantages, such as compactness for use in slim-type display devices, light mixing uniformity and high emission efficiency, the direct-lit backlight plates are advantageous in being suited for performing the local-area dimming control technique, thereby achieving an enhanced dynamic contrast ratio of images, a reduced power consumption and a constant gamut under a lower brightness level. (In a conventional LCD television, light leakage from liquid crystals normally results in a narrower gamut of colors. Therefore, in R.O.C. Patent Application No. 98141155, entitled “Stacked-Type Backlight Plate for Use in Display Device and Display Device Incorporated Same,” the inventor proposed a backlight plate having the advantages present in both of the direct-lit and edge-lit backlight plates. The backlight plate is composed of a plurality of edge-lit light guide sets and is suited for performing the local-area dimming control technique. A display device incorporating the backlight plate exhibits a remarkably enhanced performance and achieves the purposes of energy saving and environmental protection.

A major consideration regarding manufacturing of a large-size backlight plate by assembling multiple light guides is the maintenance of uniform brightness and chromaticity of the backlight plate. Due to the geometric discontinuity among joined light guides, the light emission from boundary positions are different from that from non-boundary positions, causing brightness non-uniformity between the boundary positions among light guides and the positions of the light guides remote from the boundary positions. The problem would become more serious when the backlight plate is assembled from a great number of light guides. Repeated appearance of non-uniformity in brightness would create ripples and cause regular gridlines or “mura” on displayed images and seriously deteriorate the quality of an LCD television.

In 1999, a technique was proposed in U.S. Pat. No. 6,241,358 and R.O.C. Patent No. 412716 issued to Eizaburo Higuchi et al., entitled “Tandem Surface Light Source Device”. As shown in FIG. 1, the backlight disclosed therein includes a plurality of LED light sources 111, 121, 131 and a plurality of light guides 11, 12, 13. The light guides 11, 12, 13 are each provided with a rest portion 110, 120, 130, so that a narrowed portion of the light guide 11, for example, may be placed on the rest portion 120 of the adjacent light guide 12. Scattering spots 141, 142, 143 are dispersed on the faces opposite to the light exiting faces.

Nevertheless, since a conventional light guide is normally manufactured by plastic injection molding, the respective corners of the light exiting region of the light guide that are intended to be strictly vertical in profile may not be configured as vertical as expected. As shown in FIG. 3, a corner 14′ of a conventional light guide is not at a right angle, but instead in the form of a curved face. The curved face 14′ may act like a lens, focusing the light beams reflected from scattering spots 143′ on a limited area which turns out to be a much brighter portion on the screen. Further, in a backlight plate assembled from the light guides 11, 12, 13, a discontinuous geometry exists among the light exiting regions 131, 132, 133, causing non-uniformity in light emission at joins 17, 18 among these light guides. The resultant distribution of light field intensity has a brightness non-uniformity, in which the light emission at the joints may be less brighter than that at central portions of the light exiting regions as shown in FIG. 2, or may alternatively be brighter than that at central portions as shown in FIG. 4.

In R.O.C. Patent No. 1235803, entitled “Method to Producing a Lighting Device and Said Lighting Device,” the Osram Opto Semiconductors GmbH proposed another combined-type light guide structure as shown in FIG. 5. Light sources are illustrated by way of LEDs 211, 221, 231. The respective light guides 21, 22, 23 have two parts: one being light mixing regions 212, 222, 232 configured in the form of a polyhedron structure with opposite faces parallel; and the other being light exiting regions 213, 223, 233. Scattering spots 241, 242, 243 are dispersed on the faces opposite to the light exiting faces and used for reflecting light. As compared to the light guide structure disclosed in Eizaburo Higuchi et al., this model possesses more extensive “light mixing regions” 212, 222, 232 and thus provides a better uniformity in light distribution for point light sources, such as LEDs. Such a configuration, however, still has discontinuities at joints among light guide modules, such as the geometric discontinuity present between the light exiting regions 213 and 223, and may similarly suffer the brightness non-uniformity in light emission as shown in FIG. 2 or FIG. 4.

In addition, US 20080205080 assigned to Luminance Devices Inc. discloses a light guide block configured differently from those described above, as shown in FIG. 6. Light sources are illustrated by way of LEDs 34, 35, 36. The respective light guides 31, 32, 33 are configured in the form of a complicated polyhedron and consist of two parts: one being light mixing regions 311, 321, 331 and the other being light exiting regions 312, 322, 332. Scattering spots 313, 323, 333 are dispersed on the faces opposite to the light exiting faces and used for reflecting light. The “light mixing regions” and “light exiting regions” of the light guides disclosed therein still possess substantial angular profiles which could, in reality, result in brightness non-uniformity. For example, the geometric discontinuity present between the light exiting regions 312 and 322 may similarly cause the brightness non-uniformity in light emission as shown in FIG. 2 or FIG. 4.

In particular, human eyes can easily distinguish between brightness and darkness in a short distance to an extent that a 2% difference between a ripple phase with alternate brightness/darkness and the brightness level can be recognized by human eyes. Moreover, since the backlight plates adapted for performing the local area dimming control process are assembled from multiple light guides, the uniformity in brightness is prone to appear periodically due to the brightness difference between central portions of the light guides and their joints, which can be visually perceived by consumers even more easily. Due to a severe problem regarding repeated occurrence of the uniformity in brightness, the edge-lit backlight plates composed of wedge-shaped light guides as disclosed in the prior art above would not be able to satisfy the customers' needs and fail to be suited for the local area dimming control process.

### SUMMARY OF THE INVENTION

Accordingly, a purpose of the present invention is to provide a method of unifying the backlight emission from a display device incorporating a backlight plate composed of edge-lit light guides.

Another purpose of the invention is to provide a method of unifying the light emission from a display device incorporating a backlight plate composed of edge-lit light guides, which allows the application of the local-area dimming control process to the backlight plate and eliminates the brightness non-uniformity in light emission from the backlight plate.

It is still another purpose of the invention to provide a display device incorporating a backlight plate composed of edge-lit light guides, which provides a uniform light emission.

It is still another purpose of the invention to provide a display device incorporating a backlight plate composed of edge-lit light guides, which is simple in structure and, therefore, has advantages of having an improved productivity and being cost-effective and capable of being easily assembled, repaired and replaced.

The present invention therefore provides a method of unifying the light emission from a display device incorporating a backlight plate composed of edge-lit light guides. The display device comprises a backlight plate, a liquid crystal panel disposed at a light exit side of the backlight plate and including a plurality of cells with adjustable light transmissivities for displaying an image made up of pixels, and a control device for controlling the light transmissivities of the respective cells and a memory device. The backlight comprises a plurality of light guides arranged adjacent to one another, each having a light incident face, and a plurality of light sources disposed in a manner corresponding to the light incident faces of the light guides. The memory device stores compensation data which enable unification of brightness distributions of light passing through the respective cells based on light emission intensity distributions of the corresponding light guides. The method comprises the steps of:

a) obtaining image data of multiple image signals from an image source, with the image signals governing the respective light transmissivities of the respective cells;

b) computing the image signals of the image data in a weighted manner based upon the compensation data, thereby giving compensated image data that include respective adjusted image signals for the respective corresponding cells; and

c) determining the respective light transmissivities of the respective cells in the liquid crystal panel according to the compensated image signals.

The present invention further provides a display device incorporating a backlight plate composed of edge-lit light guides. The display device comprises a backlight plate, a liquid crystal panel, a memory device and a control device. The backlight plate includes a plurality of light guides arranged adjacent to one another, each having a light incident face, and a plurality of light sources disposed in a manner corresponding to the light incident faces of the light guides. The liquid crystal panel is disposed at a light exit side of the backlight plate and includes a plurality of cells with adjustable light transmissivities for displaying an image made up of pixels. The memory device is used for storing compensation data which enable unification of brightness distributions of light passing through the respective cells based on light emission intensity distributions of the corresponding light guides. The control device is adapted for obtaining image data of multiple image signals from an image source, with the image signals governing the respective light transmissivities of the respective cells, and for computing the image signals of the image data in a weighted manner based upon the compensation data, thereby giving compensated image data that include respective adjusted image signals for the respective corresponding cells, and for determining the respective light transmissivities of the respective cells in the liquid crystal panel according to the compensated image signals.

The light emission from a backlight plate composed of edge-lit light guides often varies from one position of the backlight plate to another due to the effects of different light guides on the light emission, resulting in non-uniformity in backlight emission. According to the invention, the non-uniformity can be eliminated by weighted computing the light emission intensity distributions of the respective light guides and by obtaining the adjusted image signals for adjusting the transmissivities of the respective cells located in the liquid crystal panel. Moreover, the invention allows the application of the local-area dimming control process to the backlight plate while eliminating the brightness non-uniformity in light emission from the backlight plate.

The display device incorporating the backlight plate described above provides uniform light emission and allows the application of the local-area dimming control process to the display device. Since the light guides of the backlight plate disclosed herein are configured into a structure having opposite parallel faces as disclosed in the co-pending patent applications owned by the applicant, rather than a wedge-shaped structure, if a light beam strikes on the light incident face of the light guide at an angle smaller than a critical angle above which the total internal reflection occurs, it could be propagated in a manner of total internal reflection within the light guide. The invention allows the incident light beam to propagate through a sufficient distance for light mixing and prevents it from departing prematurely from the light guide before arriving at the light exiting region. The uniformity of light emitted from the backlight plate thus approaches ideal.

Again, since the light guides disclosed herein are configured into a structure having opposite parallel faces, they are advantageous in having an improved productivity and being cost effective and capable of being easily assembled, repaired and replaced. The inventive display device provides a market value that creates a win-win situation where both manufacturers and consumers will come satisfied. The purposes intended by the invention are achieved accordingly.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram illustrating the light guides located in a conventional tandem surface light source device;

FIG. 2 is a diagram showing the brightness profile of the light source device of FIG. 1 under the effect of multiple light guides;

FIG. 3 is an enlarged schematic diagram for the light guide of FIG. 1, showing that a corner of the light guide is not exactly at a right angle;

FIG. 4 is a diagram showing the brightness profile of the light source device of FIG. 3 under the effect of the non-right angle corner in the light guide;

FIG. 5 is a schematic diagram illustrating a conventional illuminating device which includes light guides having extensive light mixing regions;

FIG. 6 is a schematic diagram illustrating a conventional illuminating device which includes light guides configured in the form of a complicated polyhedron;

FIG. 7 is a schematic diagram illustrating the backlight plate composed of edge-lit light guides according to the first preferred embodiment of the invention;

FIG. 8 is a schematic diagram showing that the brightness level of a light guide of FIG. 7 is affected by the neighboring light guides;

FIG. 9 is a schematic diagram illustrating a display device incorporating the backlight plate of FIG. 7;

FIG. 10 is a diagram showing the light emission intensity distribution profile of the backlight plate of FIG. 7;

FIG. 11 is a diagram showing the light emission intensity distribution profile of the backlight plate of FIG. 10, which is effected by the adjusted image signal and is exactly out-phase with the profile shown in FIG. 10;

FIG. 12 is a schematic diagram showing an arrangement of edge-lit light guides in the backlight plate of FIG. 7;

FIGS. 13 and 14 show a flowchart of a method of unifying the light emission from the display device incorporating the backlight plate composed of edge-lit light guides; and

FIG. 15 is a schematic diagram for the second preferred embodiment of the invention, showing that the brightness levels of the light guides are detected by sensors.

### DETAILED DESCRIPTION OF THE INVENTION

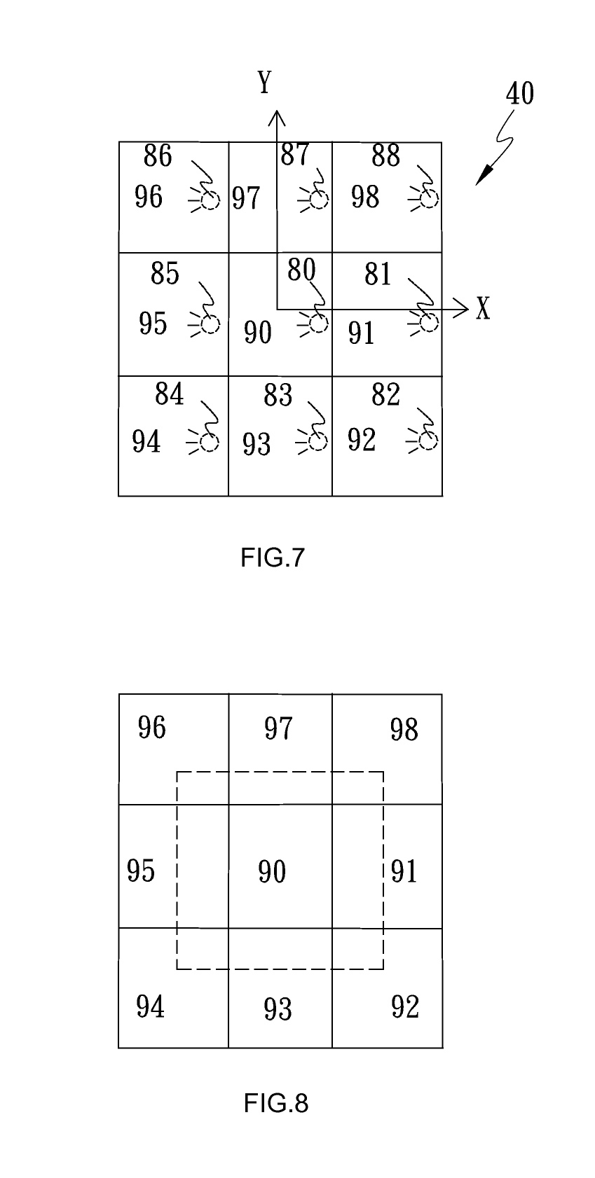

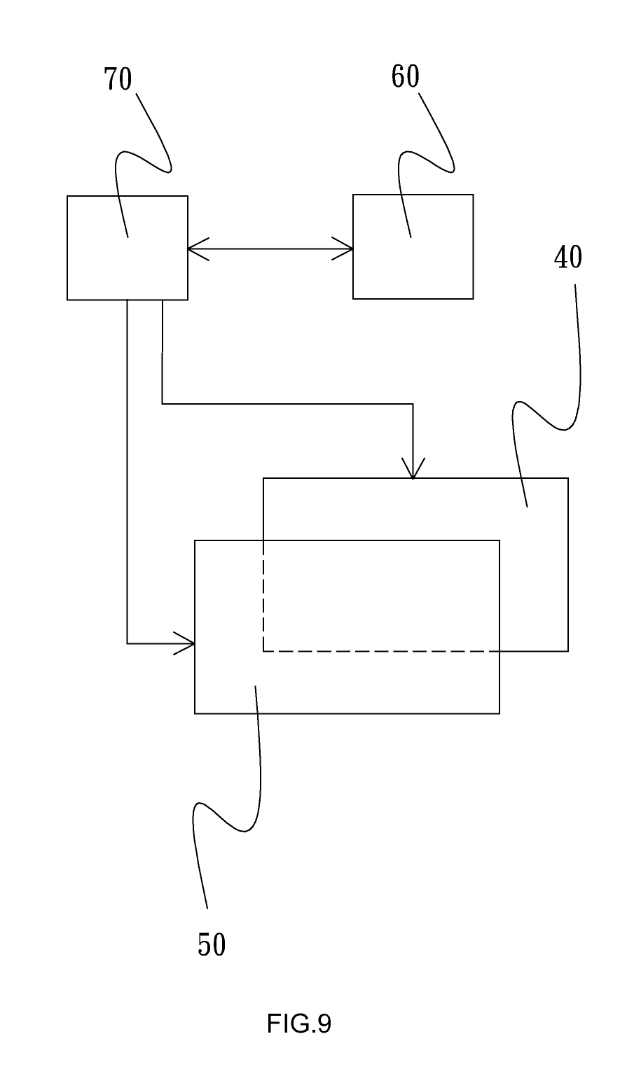

For illustrative purpose, FIG. 7 shows a portion of a backlight plate, which is derived from a complete backlight plate assembled from multiple light guides. The portion of the backlight plate includes 9 adjacent light guides designated as 90, 91 . . . 98, respectively, with the light guide 90 being centered by surrounding it with the light guides 91, 92 . . . 98. The light guides 90, 91 . . . 98 are each provided with a corresponding LED light sources 80, 81 . . . 88. In the case of the light guide 90, for example, the light beams emitted from LED 80, after travelling through the light guide 90, may contribute various degrees of brightness to different positions of a liquid crystal panel disposed in front of the backlight plate and generate the so-called “cross-talk” effect on those positions. In order to substantially measure and precisely calculate the contribution, a light emission intensity distribution data D(x,y) of a certain light guide is defined herein as a normalized value of the brightness distribution data of light emitted from the light guide to a position (x,y) in an x-y coordinate system.

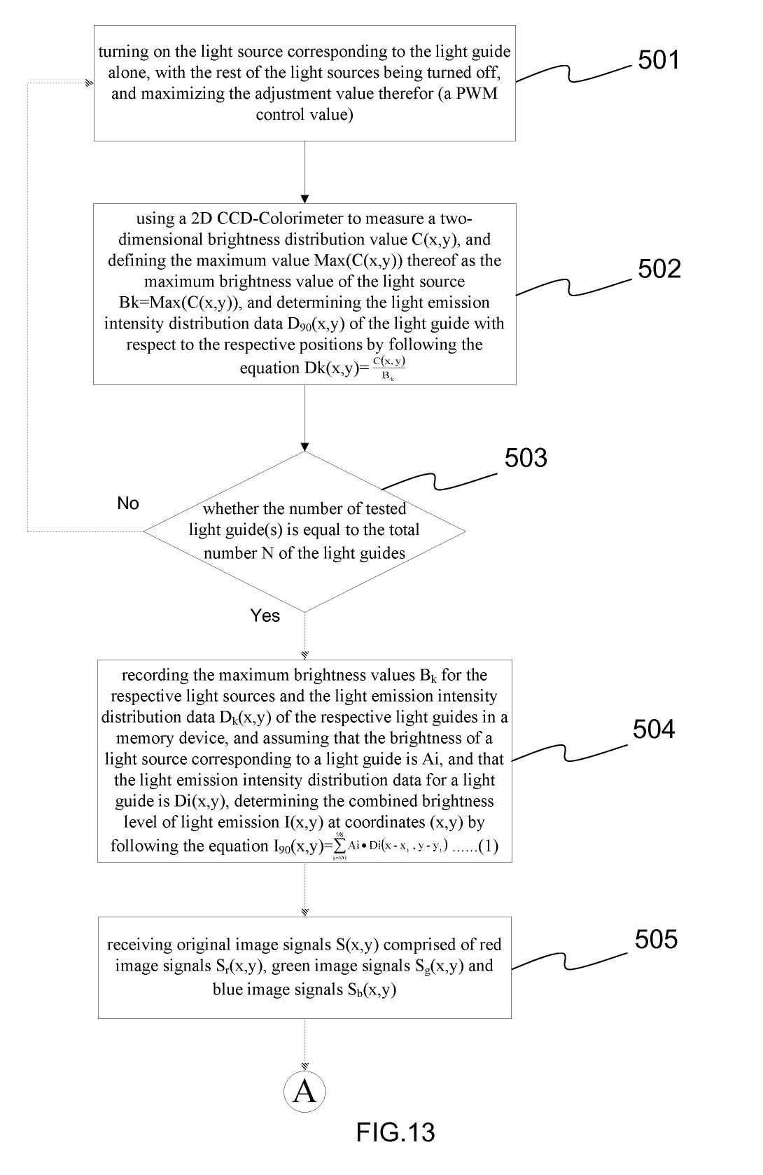

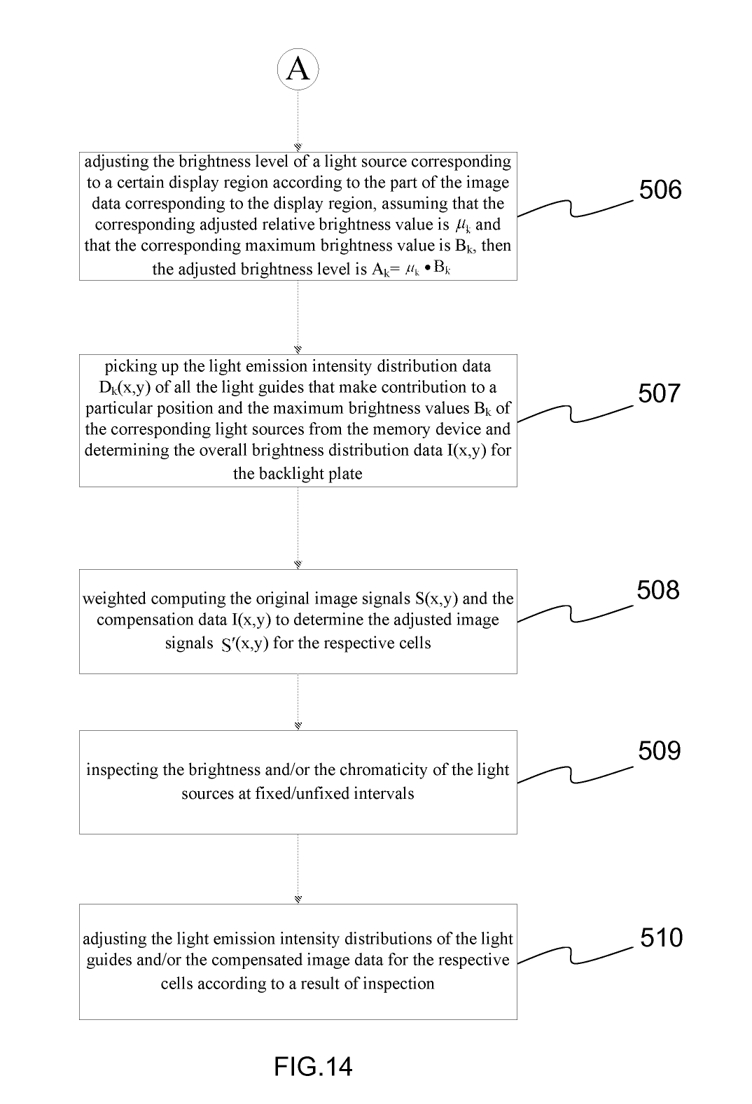

Therefore, when a light source disposed corresponding to a certain light guide is lighted up, the light emission intensity distribution data D(x,y) thus generated would possibly cover a broader range than the area of the light exiting face of the light guide. The brightness distribution data for the respective light guides 90, 91 . . . 98 are calculated by multiplying the brightness levels of the LEDs 80, 81 . . . 88 by the light emission intensity distribution data D(x,y) of the respective light guides 90, 91 . . . 98. An exemplary process for measuring the light emission intensity distribution data D(x,y) of a light guide is shown in FIGS. 13 and 14. In Step 501, the light source 80 corresponding to the light guide 90 is turned on alone, with the rest of the light sources being turned off, and the adjustment value therefor (a PWM control value) is maximized. Then, in Step 502, a two-dimensional brightness distribution value C(x,y) is measured by a 2D CCD-Colorimeter, and the maximum value Max(C(x,y)) of the two-dimensional brightness distribution value C(x,y) is determined and defined to be the maximum brightness value of the light source Bk=Max(C(x,y)). Based on the relationship equation C(x,y)=Bk·D(x,y), the value of

$$Dk ( x , y ) = \frac{C ( x , y )}{{B}_{k}}$$

is determined, and from there the light emission intensity distribution data D90(x,y) of the light guide 90 with respect to the respective positions, for example, can be determined. The coverage of D90(x,y) apparently extends to the radiated areas corresponding to the other light guides 91, 92 . . . 98.

It can be readily understood that when the light source is composed of three light sources with red, green and blue colors, readings should be obtained independently for the respective light sources of different colors. For this purpose, the inventive process has to incorporate additional loops for obtaining the readings for the respective light sources of red, green and blue colors, so as to obtain the maximum brightness values Brk, Bgk, Bbk for the light sources of respective colors and further attain the light emission intensity distribution data Drk(x,y), Drg(x,y), Dbk(x,y) for the respective colors.

After the completion of testing for the sampled light guide(s), Step 503 is carried out to determine whether there is still any light guide to be tested. The step is carried out by providing that the number of tested light guide(s) is K, and that K=K+1, and then determining whether K is equal to the total number N of the light guides. If it determines that K is smaller than N, the process would go back to Step 501 to test for the next light guide.

In other words, the total light emission intensity distribution data at a position (x,y) corresponding to the light guide 90 is a sum of the light emission from the light guide 90 to the position (x,y) and the cross-talk light emission from the adjacent light guides 91, 92, . . . 98 to the position (x,y). Since the brightness levels of all of the light sources 80, 81, 82 . . . 88 are known, the maximum brightness values Bk for the respective light sources, as well as the light emission intensity distribution data Dk(x,y) of the respective light guides 90, 91, 92 . . . 98, are recorded in a memory device in Step 504, until all of the light guides are tested and the related data thereto are recorded. Assuming that the brightness of a light source corresponding to a light guide is Ai, and that the light emission intensity distribution data for a light guide is Di(x,y), the combined brightness level of light emission I(x,y) at coordinates (x,y) corresponding to the light guide 90 is determined in light of the superposition principle to be:

$$I 90 = {\sum }_{i = 90}^{98} Ai \cdot Di ( x - {x}_{i} , y - {y}_{i} ) . \qquad ( 1 )$$

In Equation (1) above, coordinates (xi,yi) represent a central position of a light guide. Based upon the same principle, the combined brightness distribution data Ik (x,y) for the k-th light guide can be represented by the following equation:

$$Ik ( x , y ) = {\sum }_{j = 0}^{8} {A}_{kj} \cdot {D}_{kj} ( x - {x}_{kj} , y - {y}_{kj} ) . \qquad ( 2 )$$

In Equation (2) above, Ak0 represents the brightness level of the light source corresponding to the k-th light guide, wherein the brightness level of the light source is not limited to the maximum brightness value Bk. Ak1, Ak2 . . . Ak8 represent the respective brightness levels of the light sources corresponding to the eight light guides adjacent to the k-th light guide. The coordinates (xk0, yk0) represent a central position of the k-th light guide, whereas the coordinates (xkj, yki) j=1, 2 . . . 8 represent central positions of the eight light guides adjacent to the k-th light guide. Dk0 represents the light emission intensity distribution data for the k-th light guide, while Dk1, Dk2 . . . Dk8 represent the light emission intensity distribution data for the eight light guides adjacent to the k-th light guide. The overall brightness distribution data I(x,y) for the entire backlight plate can be calculated by weighted combining the respective brightness levels of the light sources corresponding to the respective light guides, based on the following equation:

$$I ( x , y ) = {\sum }_{k = 0}^{n - 1} {I}_{k} ( x , y ) . \qquad ( 3 )$$

In Equation (3) above, n represents the total number of the light guides.

A display device incorporating the backlight plate described above is illustrated in FIG. 9. A backlight plate 40 is provided at its light-exiting side with a liquid crystal panel 50 composed of a plurality of cells with variable light transmissivity. The product of the light transmissivities of the respective cells and the brightness of the backlight plate will determine the brightness and chromaticity of a pixel, and the sum of the respective pixels constitutes an entire picture. As the brightness levels of the respective LED light sources corresponding the light guides can be controlled independently, a suitable algorism may be utilized in light of the “local-area dimming control” technique after receipt of an original image signal S(x,y), so as to determine the adjusted relative brightness value μₖ of a light source corresponding to the radiated areas by the respective light guides (the cross-talk effect is not considered at this moment). The brightness value μₖ is ranged 0≦μₖ≦1. Assuming that the light source has a maximum brightness value of Bk (when μₖ=1), the adjusted brightness level of the light source is Ak=μₖ·Bk. When the cross-talk effect is taken into account, the light emission intensity distribution data at a certain position that take into account all the light guides contributing brightness to the position, i.e., Dk(x,y), as well as the maximum brightness value Bk and/or the chromaticity of the corresponding light sources, are determined and recorded in a memory device 60. For brevity, all the data regarding the relationship among positions, brightness of light sources and light emission intensity distribution are referred to hereafter as the compensation data with respect to the respective positions.

In the case where a display device receives image data and is going to display the image data, if the display device directly displays the “original image data” received, it would not be able to perform the local-area dimming control process and a mura phenomenon would occur. Now referring back to FIG. 13, after receiving original image signals S(x,y) comprised of red image signals Sr(x,y), green image signals Sg(x,y) and blue image signals Sb(x,y) in Step 505, a suitable algorism is utilized in Step 506 to determine the adjusted relative brightness values μₖ for the respective light sources corresponding to the radiated areas by the respective light guides, whereby the brightness level of a light source corresponding to a certain display region is adjusted according to the part of the image data corresponding to the display region. These brightness values μₖ are ranged 0≦μₖ≦1. When the light source has a maximum brightness value of Bk (when μₖ=1), the adjusted brightness level of the light source is Ak=μₖ·Bk.

After completion of the computation described above by a controlling device 70, in Step 507, the light emission intensity distribution data Dk(x,y) of all the light guides that make contribution to a particular position, and the maximum brightness values Bk and/or the chromaticity values of the corresponding light sources, are picked up from the memory device 60 by the controlling device 70. These data are then computed according to the equation Ak=μₖ·Bk and Equations (2) and (3) above, so as to determine the overall brightness distribution data I(x,y) for the backlight plate under the “local-area dimming control”.

In Step 508, the transmissivity of the cells located in the liquid crystal panel 50 are adjusted in correlation with the respective regions of the backlight plate by the controlling device 70 according to the so-called “adjusted image signals” S′(x,y), such that the respective original image signals S(x,y) can be resumed by allowing the controlling device 70 to multiply the overall brightness distribution data I(x,y) by the adjusted image signals S′(x,y) used to control the transmissivity of cells, based on the following relationship equation:

I(x,y)·S′(x,y)=K0·S(x,y) (4),

wherein K0 is a proportionality constant.

Equation (4) is meant to represent that controlling of the light transmissivity of the respective cells by the adjusted image signals S′(x,y) is effected concomitantly with the application of the overall brightness distribution data I(x,y) of the backlight plate 40, such that the resultant brightness of light emission S′(x,y)·I(x,y) is substantially proportional to the brightness level of the original image data. In the light of Equation (4), the “adjusted image signal” S′(x,y) can be calculated by the controlling device 70, based on the following equation:

$${S}^{′} ( x , y ) = K 0 \cdot \frac{S ( x , y )}{I ( x , y )} . \qquad ( 5 )$$

The process described above involves adjustment of the brightness of light sources and weighted computation of the image signals in the image data according to the compensation data regarding the brightness values of the respective light sources corresponding to the respective display regions corresponding to the cells that correspond to the image signals and the contribution ratios of the light emission intensity distributions of the corresponding light guides. By using a control device, a computation based on Equation (5) leads to compensated image data that correspond to the adjusted image signals for the respective cells. If the transmissivities of the respective cells located in the liquid crystal panel are determined according to the compensated image data, the so-called “local-area dimming control” would be desirably achieved and the brightness non-uniformity among the light guides would be overcome at the same time.

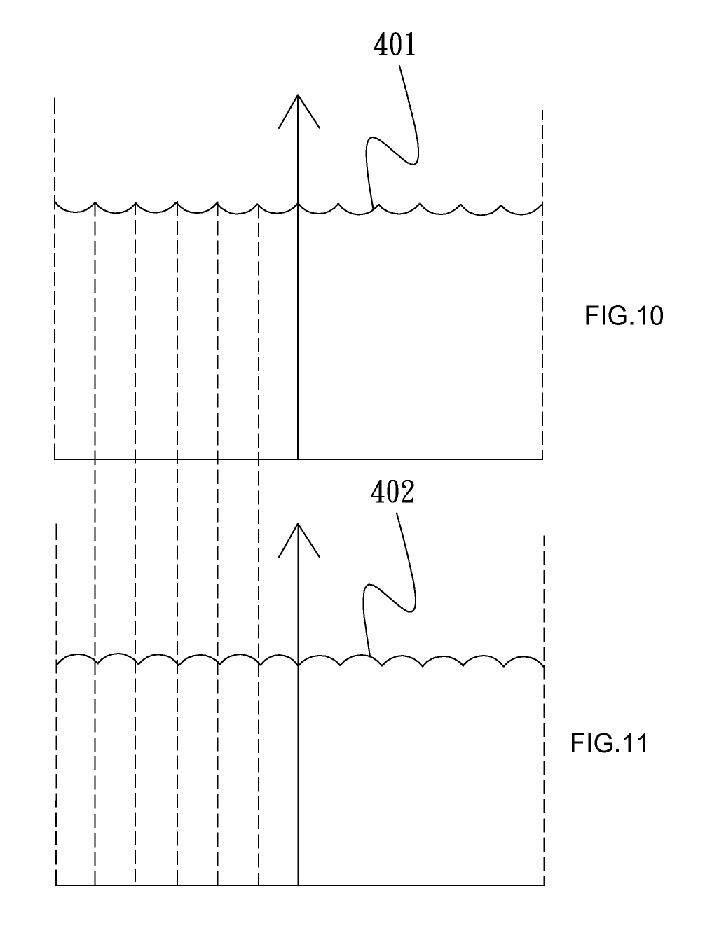

For example, assuming that the original image signal is S(x,y)=1, meaning that the frame to be displayed is uniformly white, the adjusted relative brightness values for the light sources corresponding the respective light guides are selected to be μi=1 under the “local-area dimming control”, meaning that all the LED light sources are lighted up. However, since the light emission intensity distributions of the respective light guides may not be uniform, the overall brightness distribution data I(x,y) of the backlight plate might be that shown in FIG. 10, wherein a ripple 401 is shown and represents the non-uniformity among light guide modules. The adjusted image signal S′(x,y) needed is obtained following Equation (5):

$${S}^{′} = \frac{{k}_{0}}{I ( x , y )} .$$

As shown in FIG. 11, the adjusted image signal S′(x,y) will lead to a brightness ripple 402, which is exactly out-phase with the overall brightness distribution data I(x,y) shown in FIG. 10. After controlling of the light transmissivity of the cells by the adjusted image signal S′(x,y), the overall brightness distribution data I(x,y) provided by the backlight plate are converted into an output brightness distribution S″(x,y)=K′I(x,y)·S′(x,y)=k′·kₒ=constant. It can be seen from the results that the resultant frame is uniformly white as desired and the non-uniformity among light guides is eliminated.

A color liquid crystal television is adapted for displaying an image by combining three independent red, green and blue sub-frames into a single image. The embodiment provided above is to describe the occasion where single-color light sources, such as white-light LEDs, are employed in the backlight plate. In the case where the image data are composed of a red image signal Sr(x,y), a green image signal Sg(x,y) and a blue image signal Sb(x,y), adjusted image signals S′ᵣ(x,y), S′_{g}(x,y) and S′_{b}(x,y) for the respective colors can be calculated by following Equation (5), while the overall brightness distribution data provided by the backlight plate remain represented by I(x,y). In this case:

S′ᵣ(x,y)=k0Sr(x,y)/I(x,y);

S′_{g}(x,y)=k0Sg(x,y)/I(x,y);

and

S′_{b}(x,y)=k0Sb(x,y)/I(x,y).

However, in the case where red-, green- and blue-color LEDs are used as light sources in the backlight plate, the adjusted image signals S′ᵣ(x,y), S′_{g}(x,y) and S′_{b}(x,y) for the respective colors are processed under the “local-area dimming control” to obtain the adjusted relative brightness values μᵣᵢ, μ_{gi}, μ_{bi} for the light sources of respective colors, wherein i represents any given light guide module. Following Equations (2) and (3), the overall brightness distribution data Ir(x,y), Ig(x,y) and Ib(x,y) of the backlight plate with respect to the light sources of three different colors are obtained, which are in turn converted into adjusted image signals for the respective colors by following Equation (5), namely,

$$\begin{matrix}{S}_{r}^{′} ( x , y ) = {k}_{r} \frac{{S}_{r} ( x , y )}{{I}_{r} ( x , y )} ; & ( 6 \text{-} 1 ) \\ {S}_{g}^{′} ( x , y ) = {k}_{g} \frac{{S}_{g} ( x , y )}{{I}_{g} ( x , y )} ; \\ and & ( 6 \text{-} 2 ) \\ {S}_{b}^{′} ( x , y ) = {k}_{b} \frac{{S}_{b} ( x , y )}{{I}_{b} ( x , y )} . & ( 6 \text{-} 3 )\end{matrix}$$

In Equations (6-1), (6-2) and (6-3) above, S′ᵣ(x,y), S′_{g}(x,y) and S′_{b}(x,y) represent the adjusted image signals for the respective colors.

It can be readily appreciated by those skilled in the art that while the brightness levels of light sources and the transmissivites of cells are adjusted by the control device according to the compensated image data, the brightness levels of the respective light sources could be temporarily altered due to change in ambient temperature or even permanently decay due to use over time. As a consequence, changes in the brightness of the light sources or in the light emission intensity distribution of the light guides may occur. Meanwhile, light changes in position and degree from frame to frame throughout the entire course of displaying. Therefore, in Step 509, the brightness and/or the chromaticity of the light sources are inspected at fixed/unfixed intervals. In Step 510, the light emission intensity distribution of the light guides and/or the compensated image data for adjusting the transmissivites of cells are adjusted according to the inspection result of the light sources.

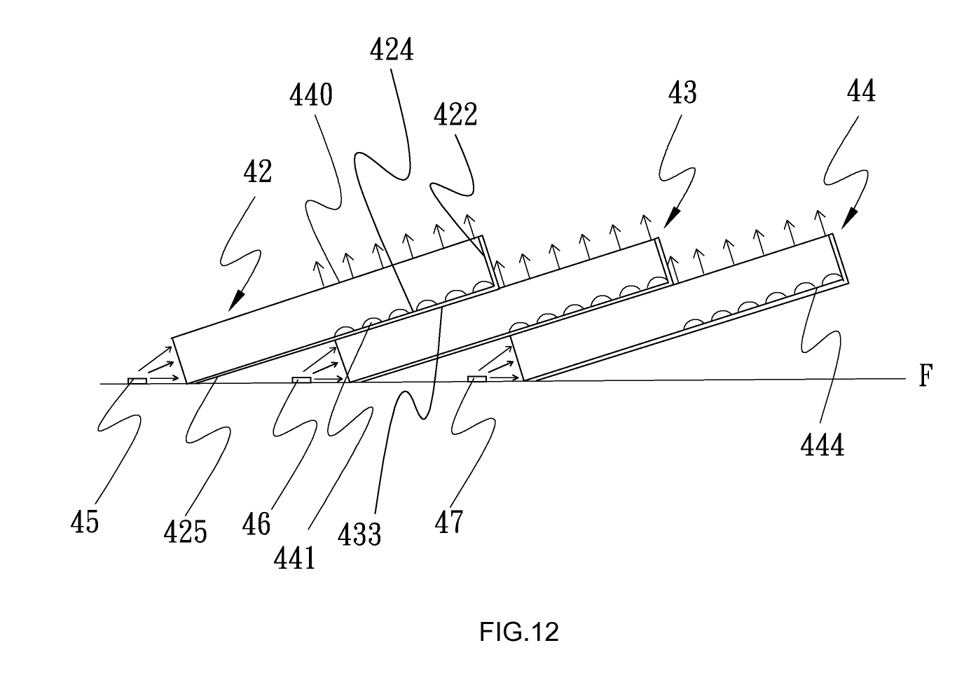

According to the invention, the edge-lit light guides may, by way of example, be arranged as shown in FIG. 12, where three light guides 42, 43, 44 are stacked in parallel fashion. The light guide 42 has a back face 424 overlapped in part with a front face 433 of the light guide 43. At the time, the portion of the front face 433 of the light guide 43 that is exposed by the back face 424 of the light guide 42 is defined as a light exiting region of the front face 433. In order to guide the light beams emitted from LEDs 45, 46, 47 to exit through the light exiting regions, the back face 444 of the light guide 44, for example, is formed at a portion opposite to the light exiting region 440 with a microstructure surface dispersed with scattering spots 441. Since the back face of the light guide has an inclined angle with respect to a bottom substrate, so that each of the light incident faces, together with a back face of a light guide located at its left side and the bottom substrate, define an accommodating space for receiving a light source, such as the LEDs 45, 46, 47. Meanwhile, in order to prevent the light beams from escaping from, for example, either the light stop face 422 or the back face 424 of the light guide 42, a reflective layer 425 is disposed on outer surfaces of the light stop face 422 and the back face 424, so that any light beams which have not exited out of the light exiting face are reflected back to the light exiting region 440 until they are properly scattered by the scattering spots 441 and emitted out of the light exiting face. This configuration may further cooperate with properly distributed scattering spots to obtain a light emission with excellent uniformity. The LED devices 45, 46, 47 may by way of example be composed of red, green and blue light-emitting diodes, or configured in the form of white-light LEDs.

If the LED light sources are stable, an excellent uniformity can be readily achieved according to the process described above. A major shortcoming of LED light sources is that they are susceptible to temperature change. Worse, the LEDs under the effects of temperature would possibly age at different rates. The temperature difference is huge from position to position within a backlight plate and this would seriously affect the stability of the LED light sources. In case of LED decay in brightness, the respective light guides would undergo a change in brightness and chromaticity, causing non-uniformity among the light guides.

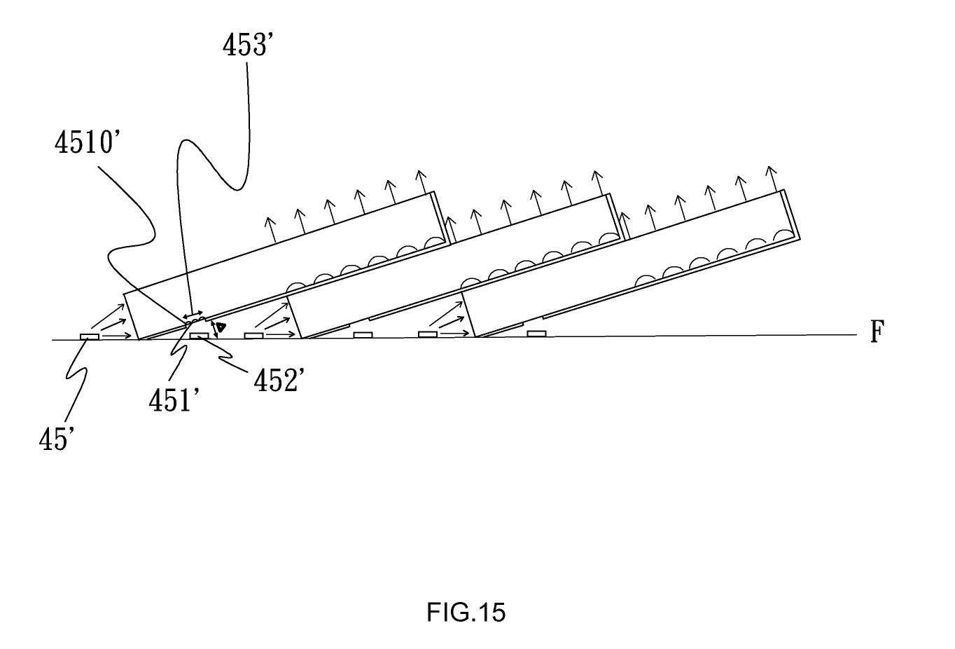

In a backlight plate according to the second preferred embodiment of the invention as shown in FIG. 15, a light leakage zone 451′ is formed at a small portion 453′ located at the back face of a light guide and in front of the microstructure surface dispersed with scattering spots, so as to allow small mount of light to exit downwards from the light guide. The dimension of the light leakage zone 451′ depends on actual needs, provided that the width thereof is smaller than that of the light guide. Meanwhile, the length Δ can be as short as down to about 1 mm. An optical sensor 452′ is mounted beneath the light leakage zone 451′, which may by way of example be a solar cell strip derived from an intact solar cell. As an alternative, the optical sensor 452′ may be one selected from a phototransistor, a photodiode or a photosensitive resistor. Preferably, the optical sensor 452′ is a solar cell strip (manufactured by dicing an intact solar cell into strips with suitable size), which is advantageous in cost effectiveness and ability of detecting light in a wide range.

As light from an LED light source 45′ enters the light guide, a small proportion of the light is allowed to leak through the light leakage zone 451′ and arrives at the optical sensor 452′. The scattering spots 4510′ are disposed in the portion 453′ at a density which depends on the sensitivity of the optical sensor 452′ and usually shows little effect upon light exiting. Since the LED light source 45′ may be composed of multiple LEDs driven by a single LED driver, the optical sensor 452′ may not be able to detect the average effect of the LEDs under the circumstance that it has a narrow detection range. However, this problem can be overcome by using a solar cell strip as the optical sensor, and the average brightness change of the LEDs can be effectively detected by taking advantage of the wide detection range of the solar cell strip. The brightness of the respective LEDs are measured by the optical sensor 452′ under standard conditions at the time when the backlight is ready to leave the plant and recorded in a memory device (E2PROM). In subsequent use, it can conveniently compare a real-time brightness of a given light source measured by the optical sensor with the standard brightness stored in the memory device, so as to resume the standard brightness through pulse-width modulation of the real-time brightness. By this way, the brightness of the light source will not be interfered with by temperature fluctuations and LED decay.

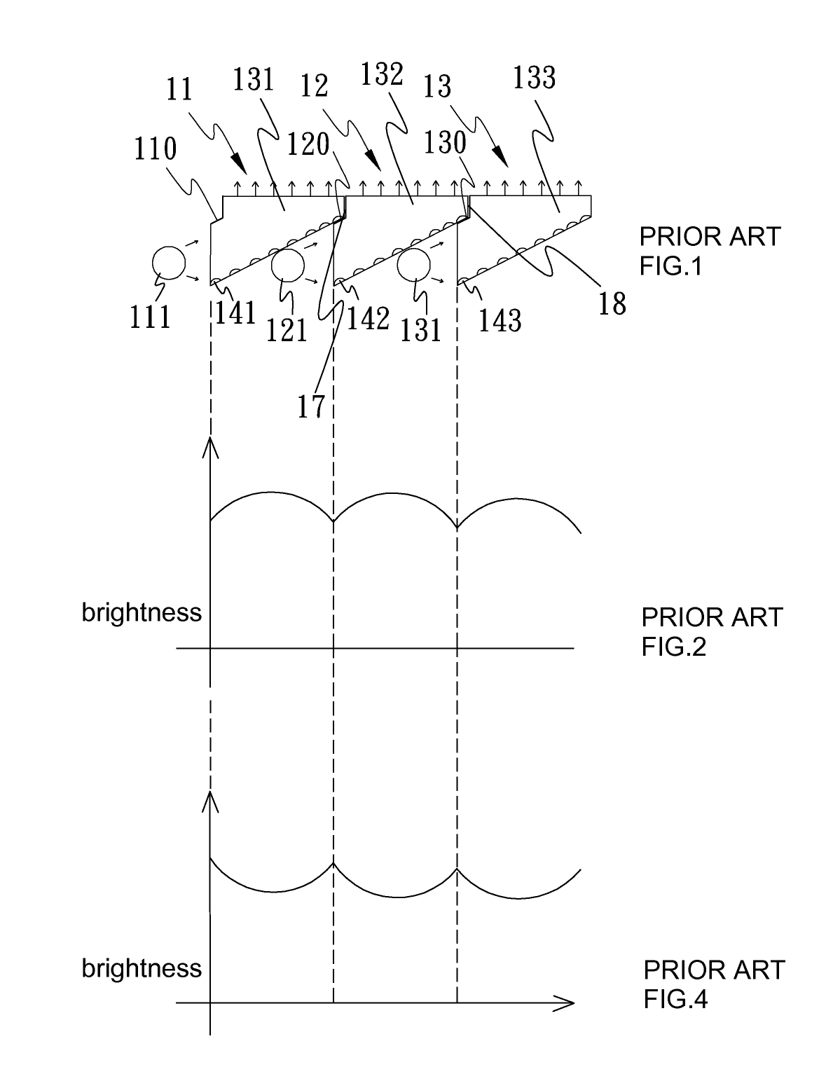

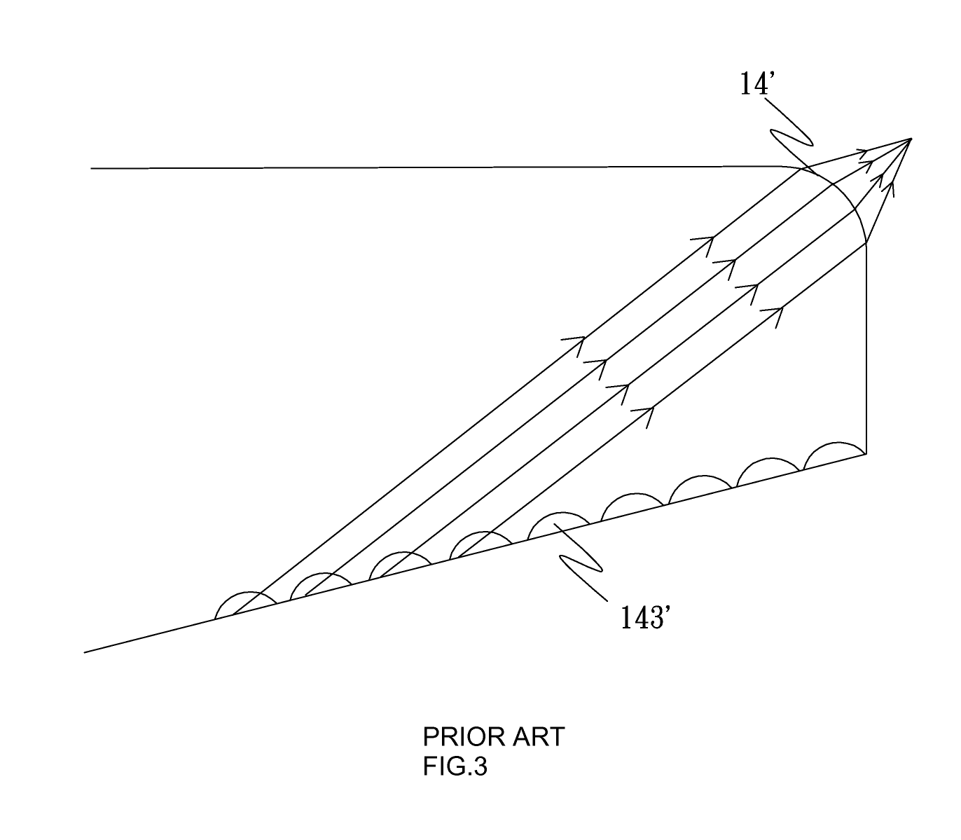

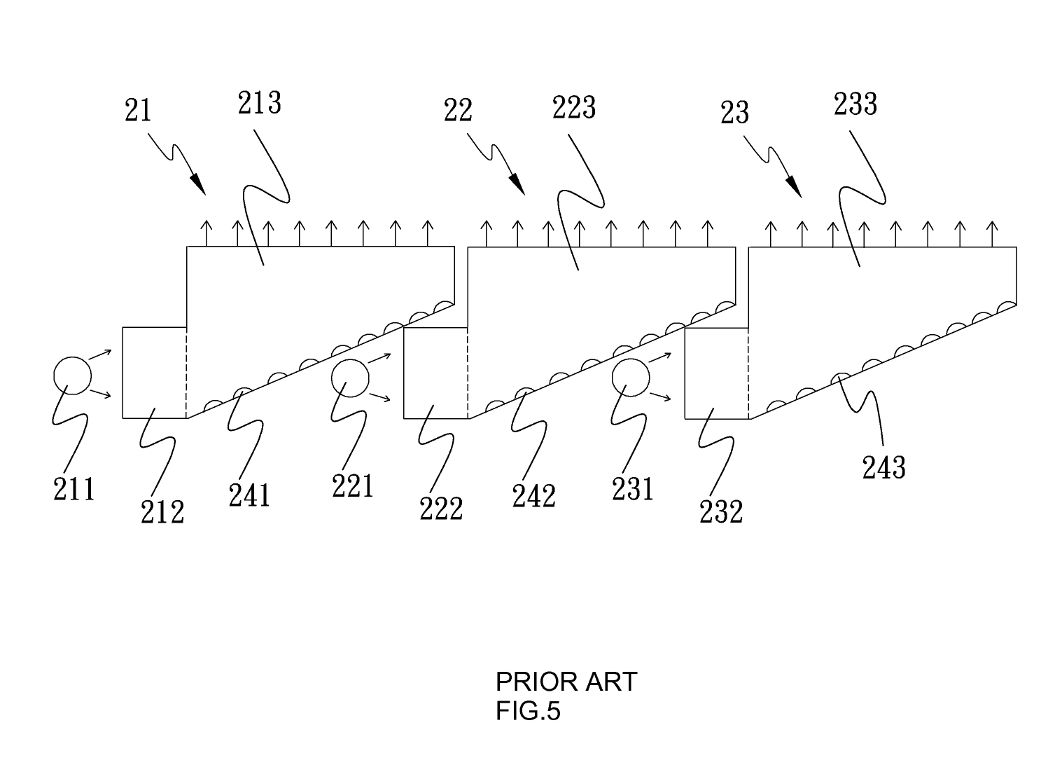

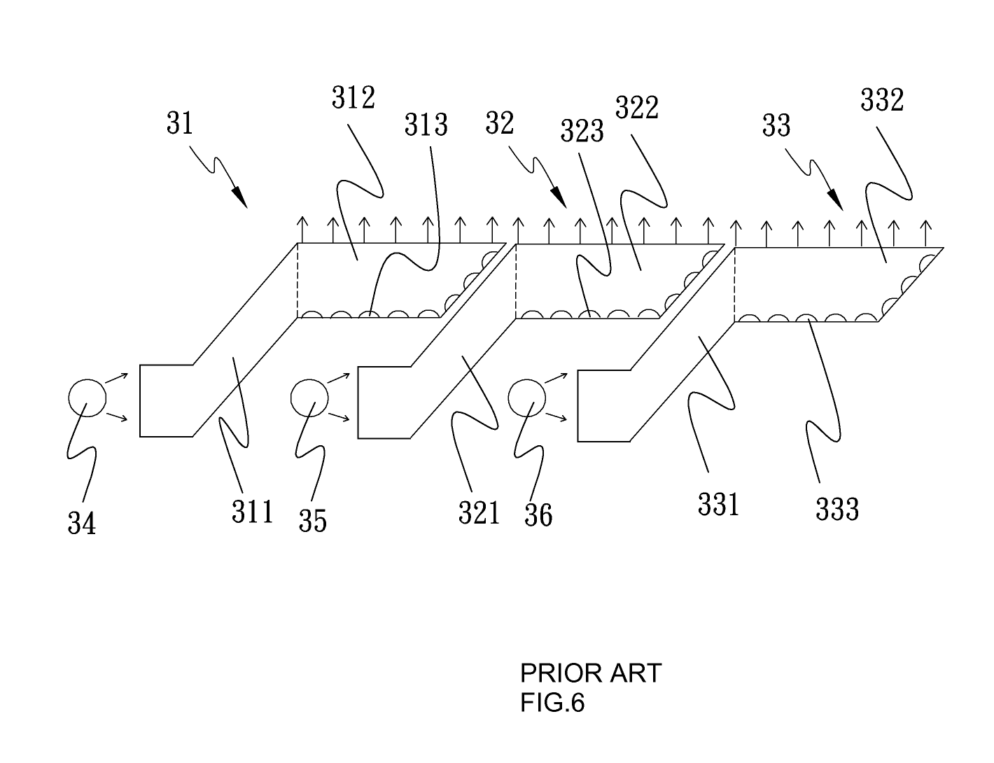

According to the aforesaid analysis, in contrast to the prior art counterparts, the light guides for use in the inventive display device are manufactured by plastic injection molding and, therefore, closely resemble to one another but not exactly identical. In the case where an extremely high uniformity is required, the light emission intensity distribution data of the respective light guides are measured and recorded, so as to calculate the overall brightness distribution data for the backlight plate based on Equations (2) and (3) as described above. In the case where an average uniformity is needed, however, the light emission intensity distribution data of the respective light guides are simply considered identical, and only the light emission intensity distribution data DS(x,y) for a standard light guide need be measured and recorded to substitute the variable Dj(x,y) in Equation (2) for the respective light guides. In this case, it is unnecessary to on-line measure the light emission intensity distribution data of the respective light guides during large-scale production, and the production speed is enhanced accordingly. Further, while the embodiments described herein involve using the backlight plates disclosed in the co-pending patent applications owned by the applicant, it can be readily appreciated by those skilled in the art that the method and apparatus disclosed herein are applicable to the prior art techniques shown in FIGS. 1, 5 and 6.

According to the invention, the backlight for use in a display and the entire picture of a liquid crystal panel are both partitioned into a large number of areas, and the respective light guides can still independently provide uniform light emission, whereby the local area dimming control technique is applicable to an edge-lit backlight plate and the slim profile of the edge-lit backlight plate is advantageously maintained. Further, since the light guides of the backlight plate disclosed herein are configured into a structure having opposite parallel faces, rather than a wedge-shaped structure, if a light beam strikes on the light incident face of the light guide at an angle smaller than a critical angle above which the total internal reflection occurs, it could be propagated in a manner of total internal reflection within the light guide. The invention allows the incident light beam to propagate through a sufficient distance for light mixing and prevents it from departing prematurely from the light guide before arriving at the light exiting region. The uniformity of light emitted from the backlight plate thus approaches ideal. The light guide disclosed herein is simple in structure and, therefore, has advantages of having an improved productivity and being cost-effective and capable of being easily assembled, repaired and replaced.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A method of unifying the light emission from a display device incorporating a backlight plate composed of edge-lit light guides, wherein the display device comprises a backlight plate, a liquid crystal panel disposed at a light exit side of the backlight plate and including a plurality of cells with adjustable light transmissivities for displaying an image made up of pixels, and a control device for controlling the light transmissivities of the respective cells and a memory device, and wherein the backlight comprises a plurality of light guides arranged adjacent to one another, each having a light incident face, and a plurality of light sources disposed in a manner corresponding to the light incident faces of the light guides, and wherein the memory device stores compensation data which enable unification of brightness distributions of light passing through the respective cells based on light emission intensity distributions of the corresponding light guides; the method comprising the steps of:
a) obtaining image data of multiple image signals from an image source, with the image signals governing the respective light transmissivities of the respective cells;
b) computing the image signals of the image data in a weighted manner based upon the compensation data, thereby giving compensated image data that include respective adjusted image signals for the respective corresponding cells; and
c) determining the respective light transmissivities of the respective cells in the liquid crystal panel according to the compensated image signals.

2. The method according to claim 1, wherein the liquid crystal panel is partitioned into a plurality of display regions in a manner corresponding to the respective light guides, and each of the display regions receives multiple brightness contributions from the light emission intensity distributions of the corresponding light guides, and wherein the step b) further comprises the steps of:
b1) changing the brightness levels of the respective light sources corresponding to the respective display regions according to the image data corresponding to the respective display regions; and
b2) weighted computing the image signals in the image data according to the compensation data regarding the brightness values of the respective light sources corresponding to the respective display regions corresponding to the cells that correspond to the image signals and the contribution ratios of the light emission intensity distributions of the corresponding light guides, so as to obtain compensated image data that correspond to the adjusted image signals for the respective cells.

3. The method according to claim 1, wherein the compensated image data for one of the cells are
$${S}^{′} ( x , y ) = {K }_{0} \cdot \frac{S ( x , y )}{I ( x , y )} ,$$
wherein K₀ is a proportionality constant and S(x,y) is an original image signal in the image data that corresponds to the cell and I(x,y) is a sum contribution from the light emission intensity distributions of the corresponding light guides received by the cell.

4. The method according to claim 1, further comprising a step d) of inspecting the brightness and/or the chromaticity of the light sources at fixed/unfixed intervals.

5. The method according to claim 4, further comprising, subsequent to the inspecting step d), a step e) of adjusting the light emission intensity distributions of the light guides and/or the compensated image data for the respective cells according to a result of inspection.

6. A display device incorporating a backlight plate composed of edge-lit light guides, comprising:
a backlight plate, including:
a plurality of light guides arranged adjacent to one another, each having a light incident face; and
a plurality of light sources disposed in a manner corresponding to the light incident faces of the light guides;
a liquid crystal panel disposed at a light exit side of the backlight plate and including a plurality of cells with adjustable light transmissivities for displaying an image made up of pixels;
a memory device that stores compensation data which enable unification of brightness distributions of light passing through the respective cells based on light emission intensity distributions of the corresponding light guides; and
a control device for obtaining image data of multiple image signals from an image source, with the image signals governing the respective light transmissivities of the respective cells, and for computing the image signals of the image data in a weighted manner based upon the compensation data, thereby giving compensated image data that include respective adjusted image signals for the respective corresponding cells, and for determining the respective light transmissivities of the respective cells in the liquid crystal panel according to the compensated image signals.

7. The display device according to claim 6, wherein each of the light guides has a front face and a back face arranged opposite and parallel to each other and disposed adjacent to the light incident face, and wherein the back face of one of any two adjacent light guides is overlapped in part with the front face of the other of the any two adjacent light guides.

8. The display device according to claim 6, further comprising a sensor for detecting the brightness and/or chromaticity levels of light emitted from the light sources and transmitting a detection result to the control device.

9. The display device according to claim 8, wherein the light guides are each formed with a light leakage zone, and wherein the sensor comprises a plurality of solar cell strips disposed in a manner corresponding to the light leakage zones.

10. The display device according to claim 6, wherein each of the light sources comprises red-, green- and blue-color light-emitting diodes.
